(19) United States
(12) Patent Application Publication
(10) Pub. No.: US 2020/0317214 A1
(43) Pub. Date: Oct. 8, 2020

(54) HYBRID VEHICLE

(71) Applicant: TOYOTA JIDOSHA KABUSHIKI KAISHA, Toyota-shi (JP)

(72) Inventors: Koichi Yonezawa, Toyota-shi (JP); Satoshi Yoshizaki, Gotenba-shi (JP); Osamu Maeda, Toyota-shi (JP); Daigo Ando, Nagoya-shi (JP); Yoshikazu Asami, Gotenba-shi (JP); Kenji Itagaki, Suntou-gun (JP); Shunsuke Oyama, Nagakute-shi (JP); Koichiro Muta, Okazaki-shi (JP)

(73) Assignee: TOYOTA JIDOSHA KABUSHIKI KAISHA, Toyota-shi (JP)

(21) Appl. No.: 16/839,350

(22) Filed: Apr. 3, 2020

(30) Foreign Application Priority Data
Apr. 5, 2019 (JP) 2019-072540

(51) Int. Cl. B60W 50/06; F02D 9/08; B60K 6/365; F02D 41/00; B60K 6/24; B60W 10/06; B60W 10/08; B60W 20/00

(52) U.S. Cl. CPC B60W 50/06; B60W 2050/0088; B60K 6/365; F02D 41/0007; B60K 6/24; B60W 10/06; B60W 10/08; B60W 20/00; F02D 2200/101; B60Y 2200/92; B60Y 2400/435; B60W 2710/0605; B60W 2710/0644; B60W 2710/08; B60W 2510/0642; F02D 9/08

(57) ABSTRACT

When a learning condition is satisfied, an ECU starts learning processing and controls opening of a throttle valve in accordance with a first map. The ECU calculates a difference between an actual rotation speed and a target rotation speed of the engine at the current time. When magnitude of the difference is equal to or larger than a prescribed value, the ECU performs second learning processing. In second learning processing, the ECU controls a first MG to set a rotation speed of the engine to an idle rotation speed by using output torque from the first MG. How much the throttle valve's opening is corrected is calculated based on torque of the first MG required for setting the rotation speed of the engine to the idle rotation speed, and opening of the throttle valve is updated. The first map is updated based on updated opening of the throttle valve.

This nonprovisional application is based on Japanese Patent Application No. 2019-072540 filed with the Japan Patent Office on Apr. 5, 2019, the entire contents of which are hereby incorporated by reference.

### BACKGROUND

### Field

The present disclosure relates to a hybrid vehicle.

### Description of the Background Art

Japanese Patent Laying-Open No. 2015-58924 discloses a hybrid vehicle including an internal combustion engine, a motor generator, and a planetary gear mechanism. The internal combustion engine, the motor generator, and an output shaft are connected to the planetary gear mechanism.

### SUMMARY

An atmospheric pressure affects an amount of air suctioned into the internal combustion engine. An area at a high altitude (high area) where the atmospheric pressure is low is lower in density of air than an area at a low altitude (low area) where the atmospheric pressure is high. Therefore, when opening of a throttle valve is equal, for example, between the high area and the low area, the amount of air suctioned into the internal combustion engine is smaller in the high area. When the density of air is varied, the amount of suctioned air may be different from a target value. Difference in amount of suctioned air from the target value may also affect output torque or a rotation speed of the internal combustion engine.

It is thus desirable to learn relation between opening of the throttle valve and an amount of air suctioned into the internal combustion engine so as to obtain a target amount of suctioned air even though a density of air is varied.

The present disclosure was made to solve the problem above, and an object thereof is to appropriately learn relation between opening of a throttle valve and an amount of air suctioned into the internal combustion engine when a density of air is varied.

(1) A hybrid vehicle according to the disclosure includes an internal combustion engine, a rotating electric machine, a planetary gear mechanism to which the internal combustion engine, the rotating electric machine, and an output shaft are connected, a throttle valve provided in an air intake passage of the internal combustion engine, and a controller that controls opening of the throttle valve in accordance with first information representing relation between opening of the throttle valve and an amount of air suctioned into the internal combustion engine. The controller performs learning processing for learning the first information while the internal combustion engine is idle. The learning processing includes processing for setting a rotation speed of the internal combustion engine to a predetermined target rotation speed by controlling the rotating electric machine and processing for learning the first information in accordance with second information representing relation between torque of the rotating electric machine required for setting the rotation speed of the internal combustion engine to the target rotation speed and an amount of correction of opening of the throttle valve.

According to the configuration, while the internal combustion engine is idle, learning processing for learning first information is performed. As learning is performed while the internal combustion engine is in an idle state which is a steady state, stable learning can be performed.

When a current density of air is different from an expected density of air (the density of air is varied), a difference may be produced between the rotation speed of the internal combustion engine while the internal combustion engine is idle and a target rotation speed. In learning processing, initially, the rotating electric machine is controlled to set the rotation speed of the internal combustion engine to the target rotation speed. For example, when an attempt to set the rotation speed of the internal combustion engine to the target rotation speed is made while opening of the throttle valve is adjusted each time, overshoot or undershoot of the rotation speed of the internal combustion engine may be caused. By employing the rotating electric machine, the rotation speed of the internal combustion engine can be set to the target rotation speed while occurrence of overshoot or undershoot of the rotation speed of the internal combustion engine is suppressed.

First information is learned based on torque of the rotating electric machine required for setting the rotation speed of the internal combustion engine to the target rotation speed. The first information can thus be learned to information suitable for the current density of air.

(2) In one embodiment, the controller performs the learning processing when magnitude of a difference between the rotation speed of the internal combustion engine while the internal combustion engine is idle and the target rotation speed is equal to or larger than a prescribed value.

As learning processing is performed, the first information can be learned to information suitable for the current density of air. On the contrary, when learning processing is performed with a large calculation error being contained, the calculation error greatly affects the first information. According to the configuration, when magnitude of the difference between the rotation speed of the internal combustion engine while the internal combustion engine is idle and the target rotation speed is equal to or larger than a prescribed value, learning processing is performed. When the rotation speed of the internal combustion engine while the internal combustion engine is idle is higher than the target rotation speed by a prescribed value or more, fuel cut control is carried out, which may compromise comfort of a user. When the rotation speed of the internal combustion engine while the internal combustion engine is idle is lower than the target rotation speed by a prescribed value or more, the internal combustion engine may stall. The first information can be learned by performing the learning processing when learning of the first information as above is required.

(3) In one embodiment, the internal combustion engine includes a forced induction device.

For example, when first information is prepared for each of a non-forced induction region and a forced induction region and the first information is selectively used, the first information used for the forced induction region is desirably learned in a prescribed state in which the forced induction device is activated. In the forced induction region, however, due to influence by variation in boost pressure, accuracy in learning may be lower than in the non-forced induction region. According to the configuration, opening of the throttle valve is controlled also in the forced induction region in accordance with the first information learned while the internal combustion engine is idle. By using the first information learned in the non-forced induction region, control of the internal combustion engine suitable for the density of air after it is varied can be carried out also in the forced induction region where it is difficult to secure accuracy in learning.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an overall configuration diagram showing an exemplary hybrid vehicle according to a first embodiment.

FIG. 2 is a diagram showing an exemplary configuration of an engine.

FIG. 3 is a diagram showing an exemplary controller of the hybrid vehicle shown in FIG. 1.

FIG. 4 is a diagram for illustrating an exemplary first map.

FIG. 5 is a nomographic chart (No. 1) showing relation between a rotation speed and torque of an engine, a first MG, and an output element when a vehicle is stopped and an engine is idle.

FIG. 6 is a nomographic chart (No. 2) showing relation between a rotation speed and torque of the engine, the first MG, and the output element when the vehicle is stopped and the engine is idle.

FIG. 7 is a nomographic chart (No. 3) showing relation between a rotation speed and torque of the engine, the first MG, and the output element when the vehicle is stopped and the engine is idle.

FIG. 8 is a nomographic chart (No. 4) showing relation between a rotation speed and torque of the engine, the first MG, and the output element when the vehicle is stopped and the engine is idle.

FIG. 9 is a diagram for illustrating an exemplary second map.

FIG. 10 is a flowchart showing a procedure in processing performed by an ECU.

### DESCRIPTION OF THE PREFERRED EMBODIMENTS

An embodiment of the present disclosure will be described in detail below with reference to the drawings. The same or corresponding elements in the drawings have the same reference characters allotted and description thereof will not be repeated.

<Overall Configuration>

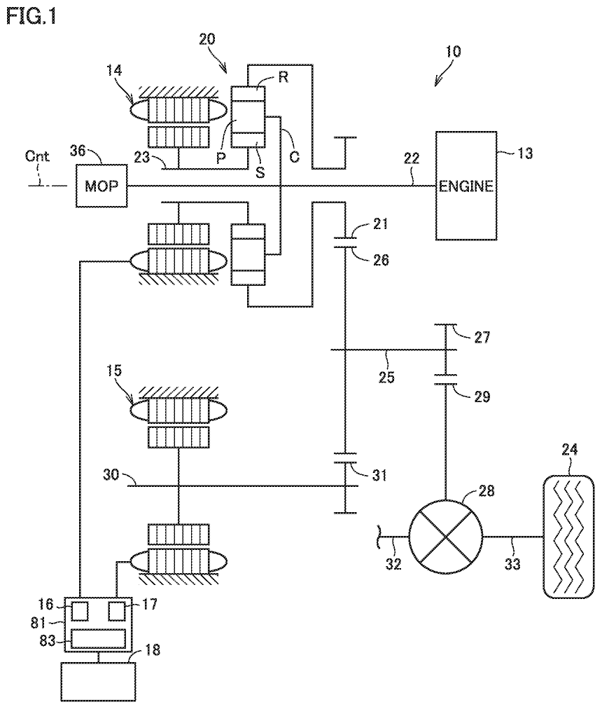

FIG. 1 is an overall configuration diagram showing an exemplary hybrid vehicle according to a first embodiment. Referring to FIG. 1, this hybrid vehicle (which is also simply referred to as a “vehicle” below) 10 includes an engine 13, a first motor generator (which is also referred to as a “first MG” below) 14, a second motor generator (which is also referred to as a “second MG” below) 15, and a planetary gear mechanism 20.

First MG 14 and second MG 15 each perform a function as a motor that outputs torque by being supplied with driving electric power and a function as a generator that generates electric power by being supplied with torque. An alternating current (AC) rotating electric machine is employed for first MG 14 and second MG 15. The AC rotating electric machine includes, for example, a permanent magnet synchronous motor including a rotor having a permanent magnet embedded.

First MG 14 and second MG 15 are electrically connected to a power storage 18 with a power control unit (PCU) 81 being interposed. PCU 81 includes a first inverter 16 that supplies and receives electric power to and from first MG 14, a second inverter 17 that supplies and receives electric power to and from second MG 15, and a converter 83.

Converter 83 supplies and receives electric power to and from power storage 18 as well as first inverter 16 and second inverter 17. For example, converter 83 can up-convert electric power from power storage 18 and supply up-converted electric power to first inverter 16 or second inverter 17. Alternatively, converter 83 can down-convert electric power supplied from first inverter 16 or second inverter 17 and supply down-converted electric power to power storage 18.

First inverter 16 can convert direct current (DC) power from converter 83 into AC power and supply AC power to first MG 14. Alternatively, first inverter 16 can convert AC power from first MG 14 into DC power and supply DC power to converter 83.

Second inverter 17 can convert DC power from converter 83 into AC power and supply AC power to second MG 15. Alternatively, second inverter 17 can convert AC power from second MG 15 into DC power and supply DC power to converter 83.

PCU 81 charges power storage 18 with electric power generated by first MG 14 or second MG 15 or drives first MG 14 or second MG 15 with electric power from power storage 18.

Power storage 18 is mounted on vehicle 10 as a drive power supply (that is, a motive power source) of vehicle 10. Power storage 18 includes a plurality of stacked batteries. Examples of the battery include secondary batteries such as a nickel metal hydride battery and a lithium ion battery. The battery may be a battery containing a liquid electrolyte between a positive electrode and a negative electrode or a battery containing a solid electrolyte (an all-solid-state battery). Power storage 18 should only be a rechargeable DC power supply, and a large-capacity capacitor can also be adopted.

Engine 13 and first MG 14 are coupled to planetary gear mechanism 20. Planetary gear mechanism 20 transmits output torque of engine 13 by dividing output torque into output torque to first MG 14 and output torque to an output gear 21. Planetary gear mechanism 20 includes, for example, a single-pinion planetary gear mechanism and is arranged on an axis Cnt coaxial with an output shaft 22 of engine 13.

Planetary gear mechanism 20 includes a sun gear S, a ring gear R arranged coaxially with sun gear S, a pinion gear P meshed with sun gear S and ring gear R, and a carrier C holding pinion gear P in a rotatable and revolvable manner. Engine 13 has output shaft 22 coupled to carrier C. A rotor shaft 23 of first MG 14 is coupled to sun gear S. Ring gear R is coupled to output gear 21.

Carrier C to which output torque of engine 13 is transmitted functions as an input element, ring gear R that outputs torque to output gear 21 functions as an output element, and sun gear S to which rotor shaft 23 of first MG 14 is coupled functions as a reaction force element. Namely, planetary gear mechanism 20 divides output from engine 13 into output on a side of first MG 14 and output on a side of output gear 21. First MG 14 is controlled to output torque in accordance with output torque of engine 13.

A countershaft 25 is arranged in parallel to axis Cnt. Countershaft 25 is provided with a driven gear 26 meshed with output gear 21. A drive gear 27 is further provided in countershaft 25, and drive gear 27 is meshed with a ring gear 29 in a differential gear 28. A drive gear 31 provided in a rotor shaft 30 of second MG 15 is meshed with driven gear 26. Therefore, output torque of second MG 15 is added to torque output from output gear 21 in driven gear 26. Torque thus combined is transmitted to drive wheel 24 with driveshafts 32 and 33 extending laterally from differential gear 28 being interposed. As drive torque is transmitted to drive wheel 24, driving force is generated in vehicle 10.

A mechanical oil pump (which is also referred to as an “MOP” below) 36 is provided coaxially with output shaft 22 of engine 13. MOP 36 delivers lubricating oil with a cooling function, for example, to planetary gear mechanism 20, first MG 14, second MG 15, and differential gear 28.

<Configuration of Engine>

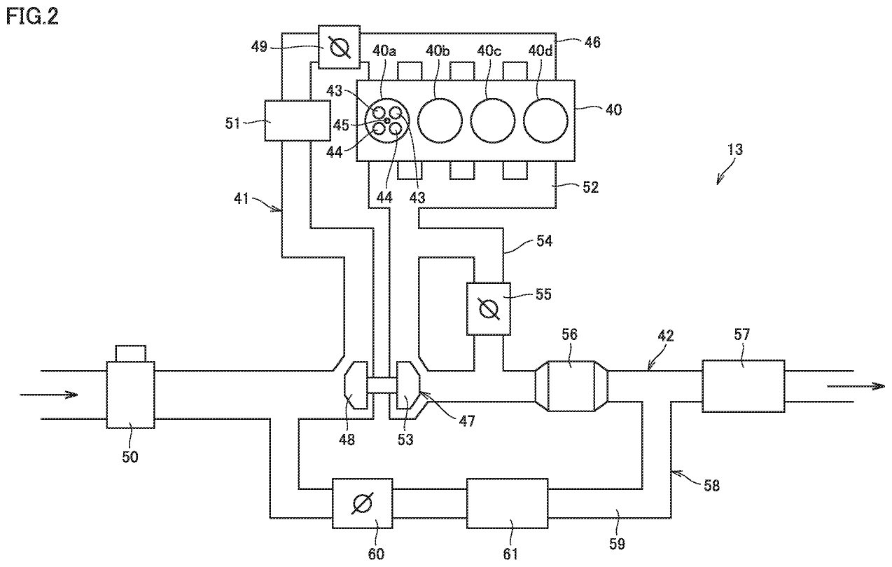

FIG. 2 is a diagram showing an exemplary configuration of engine 13. Referring to FIG. 2, engine 13 is, for example, an in-line four-cylinder spark ignition internal combustion engine including a forced induction device 47. As shown in FIG. 2, engine 13 includes, for example, an engine main body 40 formed with four cylinders 40a, 40b, 40c, and 40d being aligned in one direction.

One ends of intake ports and one ends of exhaust ports formed in engine main body 40 are connected to cylinders 40a, 40b, 40c, and 40d. One end of the intake port is opened and closed by two intake valves 43 provided in each of cylinders 40a, 40b, 40c, and 40d. One end of the exhaust port is opened and closed by two exhaust valves 44 provided in each of cylinders 40a, 40b, 40c and 40d. The other ends of the intake ports of cylinders 40a, 40b, 40c, and 40d are connected to an intake manifold 46. The other ends of the exhaust ports of cylinders 40a, 40b, 40c, and 40d are connected to an exhaust manifold 52.

Engine 13 according to the first embodiment is, for example, a direct injection engine and fuel is injected into each of cylinders 40a, 40b, 40c, and 40d by a fuel injector (not shown) provided at the top of each cylinder. An air fuel mixture of fuel and intake air in cylinders 40a, 40b, 40c, and 40d is ignited by an ignition plug 45 provided in each of cylinders 40a, 40b, 40c, and 40d.

FIG. 2 shows intake valve 43, exhaust valve 44, and ignition plug 45 provided in cylinder 40a and does not show intake valve 43, exhaust valve 44, and ignition plug 45 provided in other cylinders 40b, 40c, and 40d.

Engine 13 is provided with forced induction device 47 that uses exhaust energy to boost suctioned air. Forced induction device 47 includes a compressor 48 and a turbine 53.

An intake air passage 41 has one end connected to intake manifold 46 and the other end connected to an air inlet. Compressor 48 is provided at a prescribed position in intake air passage 41. An air flow meter 50 that outputs a signal in accordance with a flow rate of air that flows through intake air passage 41 is provided between the other end (air inlet) of intake air passage 41 and compressor 48. An intercooler 51 that cools intake air pressurized by compressor 48 is disposed in intake air passage 41 provided downstream from compressor 48. A throttle valve 49 that can regulate a flow rate of intake air (an amount of suctioned air) that flows through intake air passage 41 is provided between intercooler 51 and intake manifold 46.

An exhaust passage 42 has one end connected to exhaust manifold 52 and the other end connected to a muffler (not shown). Turbine 53 is provided at a prescribed position in exhaust passage 42. In exhaust passage 42, a bypass passage 54 that bypasses exhaust upstream from turbine 53 to a portion downstream from turbine 53 and a waste gate valve 55 provided in the bypass passage and capable of regulating a flow rate of exhaust guided to turbine 53 are provided. Therefore, a flow rate of exhaust that flows into turbine 53, that is, a boost pressure of suctioned air, is regulated by controlling a position of waste gate valve 55. Exhaust that passes through turbine 53 or waste gate valve 55 is purified by a start catalyst converter 56 and an aftertreatment apparatus 57 provided at prescribed positions in exhaust passage 42, and thereafter emitted into the atmosphere. Start catalyst converter 56 and aftertreatment apparatus 57 contain, for example, a three-way catalyst.

Engine 13 is provided with an exhaust gas recirculation (EGR) apparatus 58 that has exhaust flow into intake air passage 41. EGR apparatus 58 includes an EGR passage 59, an EGR valve 60, and an EGR cooler 61. EGR passage 59 allows some of exhaust to be taken out of exhaust passage 42 as EGR gas and guides EGR gas to intake air passage 41. EGR valve 60 regulates a flow rate of EGR gas that flows through EGR passage 59. EGR cooler 61 cools EGR gas that flows through EGR passage 59. EGR passage 59 connects a portion of exhaust passage 42 between start catalyst converter 56 and aftertreatment apparatus 57 to a portion of intake air passage 41 between compressor 48 and air flow meter 50.

<Configuration of ECU>

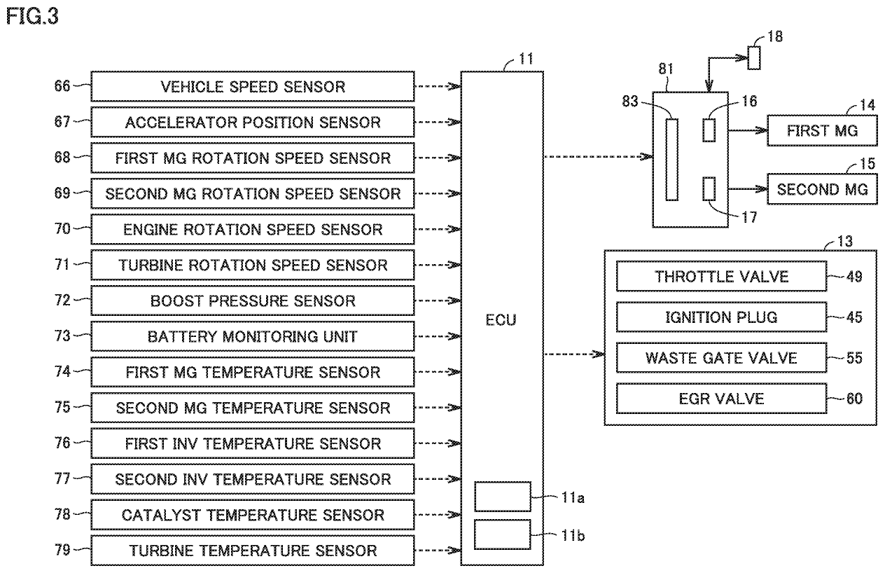

FIG. 3 is a diagram showing an exemplary controller (which is also referred to as an “electronic control unit (ECU)” below) 11 of hybrid vehicle 10 shown in FIG. 1. ECU 11 includes an input and output apparatus that supplies and receives signals to and from various sensors and other devices, a storage 11 a that stores various control programs or maps (including a read only memory (ROM) and a random access memory (RAM)), a central processing unit (CPU) 11b that executes a control program, and a counter that counts time. Storage 11a can also separately be provided outside ECU 11.

ECU 11 controls operations by engine 13. ECU 11 controls first MG 14 and second MG 15 by controlling operations by PCU 81. Though an example in which ECU 11 according to the present embodiment is implemented as one device is described, ECU 11 may be implemented, for example, by a plurality of controllers. For example, ECU 11 may include an HV-ECU for control of engine 13, first MG 14, and second MG 15 in coordination, an MG-ECU for control of operations by PCU 81, and an engine ECU for control of operations by engine 13.

A vehicle speed sensor 66, an accelerator position sensor 67, a first MG rotation speed sensor 68, a second MG rotation speed sensor 69, an engine rotation speed sensor 70, a turbine rotation speed sensor 71, a boost pressure sensor 72, a battery monitoring unit 73, a first MG temperature sensor 74, a second MG temperature sensor 75, a first INV temperature sensor 76, a second INV temperature sensor 77, a catalyst temperature sensor 78, and a turbine temperature sensor 79 are connected to ECU 11.

Vehicle speed sensor 66 detects a speed of vehicle 10 (vehicle speed). Accelerator position sensor 67 detects an amount of pressing of an accelerator pedal (accelerator position). First MG rotation speed sensor 68 detects a rotation speed of first MG 14. Second MG rotation speed sensor 69 detects a rotation speed of second MG 15. Engine rotation speed sensor 70 detects a rotation speed of output shaft 22 of engine 13 (engine rotation speed). Turbine rotation speed sensor 71 detects a rotation speed of turbine 53 of forced induction device 47. Boost pressure sensor 72 detects a boost pressure of engine 13. First MG temperature sensor 74 detects an internal temperature of first MG 14 such as a temperature associated with a coil or a magnet. Second MG temperature sensor 75 detects an internal temperature of second MG 15 such as a temperature associated with a coil or a magnet. First INV temperature sensor 76 detects a temperature of first inverter 16 such as a temperature associated with a switching element. Second INV temperature sensor 77 detects a temperature of second inverter 17 such as a temperature associated with a switching element. Catalyst temperature sensor 78 detects a temperature of aftertreatment apparatus 57. Turbine temperature sensor 79 detects a temperature of turbine 53. Various sensors output signals indicating results of detection to ECU 11.

Battery monitoring unit 73 obtains a state of charge (SOC) representing a ratio of a remaining amount of charge to a full charge capacity of power storage 18 and outputs a signal indicating the obtained SOC to ECU 11. Battery monitoring unit 73 includes, for example, a sensor that detects a current, a voltage, and a temperature of power storage 18. Battery monitoring unit 73 obtains an SOC by calculating the SOC based on the detected current, voltage, and temperature of power storage 18. Various known approaches such as an approach by accumulation of current values (coulomb counting) or an approach by estimation of an open circuit voltage (OCV) can be adopted as a method of calculating an SOC.

<Control of Vehicle>

Vehicle 10 can be set or switched to an HV traveling mode in which engine 13 and second MG 15 serve as motive power sources and an EV traveling mode in which the vehicle travels with engine 13 remaining stopped and second MG 15 being driven by electric power in power storage 18. Mode setting and mode switching are made by ECU 11. The EV traveling mode is selected, for example, in a low-load operation region where a vehicle speed is low and requested driving force is low, and in this mode, engine 13 is stopped and output torque of second MG 15 is used as a source of drive for traveling. The HV traveling mode is selected in a high-load operation region where a vehicle speed is high and requested driving force is high, and in this mode, combined torque of output torque of engine 13 and output torque of second MG 15 is used as a source of drive for traveling.

In the HV traveling mode, in transmitting torque output from engine 13 to drive wheel 24, first MG 14 applies reaction force to planetary gear mechanism 20. Therefore, sun gear S functions as a reaction force element. In other words, in order to apply output torque of engine 13 to drive wheel 24, first MG 14 is controlled to output reaction torque against output torque of engine 13. In this case, regenerative control in which first MG 14 functions as a generator can be carried out.

Specifically, ECU 11 determines requested driving force based on an accelerator position determined by an amount of pressing of the accelerator pedal or a vehicle speed and calculates requested power of engine 13 based on the requested driving force. ECU 11 variously controls each component of engine 13 such as throttle valve 49, ignition plug 45, waste gate valve 55, and EGR valve 60 based on calculated requested power.

ECU 11 determines based on calculated requested power, an operating point (a rotation speed and output torque) of engine 13 in a coordinate system defined by a rotation speed Ne of engine 13 and output torque Te of engine 13. ECU 11 sets, for example, an intersection between an equal power line equal in output to requested power in the coordinate system and a predetermined operating line as the operating point of engine 13. The predetermined operating line represents a trace of variation in engine torque with variation in rotation speed Ne of engine 13 in the coordinate system. The operating line is set, for example, by adapting the trace of variation in output torque Te of engine 13 high in fuel efficiency through experiments.

ECU 11 calculates a required amount of air suctioned into engine 13 based on requested torque of engine 13 calculated based on requested power. ECU 11 calculates opening of throttle valve 49 based on the calculated amount of suctioned air and controls throttle valve 49. A first map which is information representing relation between opening of throttle valve 49 and an amount of air suctioned into engine 13 is used for controlling throttle valve 49.

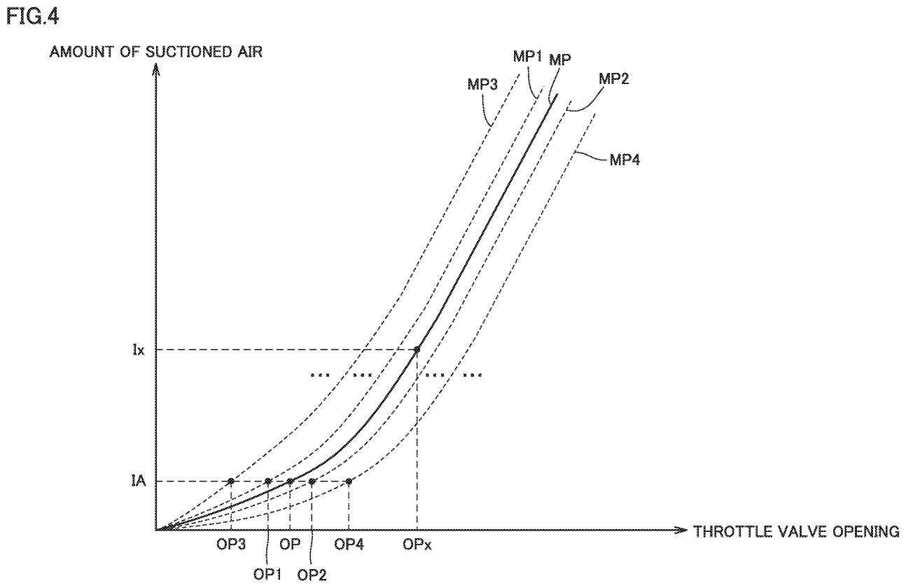

FIG. 4 is a diagram for illustrating an exemplary first map. The abscissa in FIG. 4 represents opening of throttle valve 49 and the ordinate represents an amount of air suctioned into engine 13. FIG. 4 shows a plurality of first maps MP1, MP2, MP3, and MP4 including a current first map MP by way of example. Each of first maps MP, MP1, MP2, MP3, and MP4 is determined for each density of air based on specifications of engine 13, throttle valve 49, and air intake passage 41. The first map is stored in storage 11 a. The first map corresponds to exemplary “first information” according to the present disclosure.

ECU 11 determines opening of throttle valve 49 by checking an amount of suctioned air required for output of requested power against first map MP. For example, when the amount of suctioned air required for output of requested power is set to an amount of suctioned air Ix as shown in FIG. 4, amount of suctioned air Ix is checked against first map MP to thereby obtain opening OPx of throttle valve 49.

Referring again to FIG. 3, ECU 11 controls torque and the rotation speed of first MG 14 based on the operating point above. Torque and the rotation speed of first MG 14 can arbitrarily be controlled in accordance with a value of a fed current or a frequency thereof. In the HV traveling mode, ECU 11 controls also second MG 15 such that requested driving force determined in accordance with an accelerator position or a vehicle speed is output to output gear 21 (drive wheel 24).

When torque Te of engine 13 exceeds a prescribed level (a forced induction line) by pressing of an accelerator pedal, ECU 11 starts forced induction by forced induction device 47 to increase a boost pressure with increase in torque Te. Start of forced induction and increase in boost pressure are realized by controlling waste gate valve 55 in a closing direction. When there is no request for forced induction, waste gate valve 55 is fully opened.

When the vehicle remains stopped (an amount of pressing of the accelerator pedal is zero) and engine 13 is idle, ECU 11 performs learning processing which will be described later and thereafter carries out idling stop control for stopping rotation of engine 13.

<Learning Processing>

An atmospheric pressure affects an amount of air suctioned into engine 13. A high area where the atmospheric pressure is low is lower in density of air than a low area where the atmospheric pressure is high. Therefore, when opening of throttle valve 49 is equal, for example, between the high area and the low area, the amount of air suctioned into engine 13 is smaller in the high area. When the density of air is varied, the amount of suctioned air may be different from a target value. Difference in amount of suctioned air from the target value may also affect output torque or a rotation speed of engine 13.

Vehicle 10 according to the present embodiment performs learning processing for learning information (first map) representing relation between opening of throttle valve 49 and the amount of suctioned air so as to obtain the target amount of suctioned air even though the density of air is varied. Learning processing according to the present embodiment includes first learning processing and second learning processing which will be described later. The learning processing will sequentially be described below.

The learning processing according to the present embodiment is performed when a learning condition is satisfied, the learning condition being a condition that the vehicle is stopped and engine 13 is idle. As the learning processing is performed while engine 13 is in the idle state which is the steady state, stable learning can be performed.

When the vehicle is stopped and engine 13 is idle, a target rotation speed (which is also referred to as an “idle rotation speed” below) Nad of engine 13 and torque (which is also referred to as “idle torque” below) Tad of engine 13 required for maintaining idle rotation speed Nad are determined.

ECU 11 calculates a required amount of air suctioned into engine 13 based on idle torque Tad and calculates opening of throttle valve 49 for obtaining the amount of suctioned air in accordance with the first map described above. ECU 11 then controls throttle valve 49 to be opened to the calculated opening and compares a rotation speed (which is also referred to as an “actual rotation speed” below) Ner of engine 13 with idle rotation speed Nad representing a target value. A difference ΔN between them is calculated, for example, in accordance with an expression (1) below.

ΔN=Ner−Nad (1)

Difference ΔN is assumed to result mainly from variation in density of air. Relation between difference ΔN and an amount of variation in density of air can be determined in advance through experiments. Relation between an amount of variation in density of air and an amount of correction of opening of throttle valve 49 can also be determined in advance through experiments. Therefore, relation between difference ΔN and an amount of correction of opening can be determined in advance.

By calculating difference ΔN, an amount of correction of opening of throttle valve 49 can be calculated. Though details will be described later, first information can be learned based on the amount of correction of opening of throttle valve 49.

For example, difference ΔN may contain a relatively large calculation error. When the first map is learned based on difference ΔN in such a case, accuracy in learning may be lowered. For example, learning using a prescribed weight coefficient may be performed in consideration of influence by the calculation error onto the first map. In this case, through a plurality of times of learning processing, the first map is learned to a map suitable for a current density of air.

When actual rotation speed Ner of engine 13 while the vehicle is stopped and engine 13 is idle is higher than idle rotation speed Nad by a prescribed value or more, however, fuel cut control may be carried out, which may compromise comfort of the user. When actual rotation speed Ner of engine 13 while the vehicle is stopped and engine 13 is idle is lower than idle rotation speed Nad by a prescribed value or more, engine 13 may stall. When magnitude of difference ΔN is equal to or larger than a prescribed value as above, learning of the first map is desirably completed early.

ECU 11 performs different learning processing depending on whether or not magnitude of difference ΔN is equal to or larger than a prescribed value. Specifically, ECU 11 performs first learning processing when magnitude of difference ΔN is smaller than the prescribed value and performs second learning processing when magnitude of difference ΔN is equal to or larger than the prescribed value. Details of first learning processing and second learning processing will sequentially be described below.

<<First Learning Processing>>

When magnitude of difference ΔN is smaller than the prescribed value, first learning processing is performed. In first learning processing, opening of throttle valve 49 for obtaining an amount IA of suctioned air calculated based on idle torque Tad is learned by weighting an amount Cv of correction of opening of throttle valve 49 calculated based on difference ΔN. Specifically, opening OP of throttle valve 49 is learned in accordance with an expression (2) below. A coefficient w is a weight coefficient and can be set as appropriate.

OP=OP+(Cv×w) (2)

Opening of throttle valve 49 for obtaining amount IA of suctioned air is thus updated.

Referring to FIG. 4, for example, OP1 is assumed as opening of throttle valve 49 for obtaining updated amount IA of suctioned air. In this case, first map MP1 that passes through amount IA of suctioned air and opening OP1 can be concluded as the first map calculatively suitable for the current density of air. ECU 11 then updates first map MP to first map MP1.

As can be seen in the expression (2), the weight coefficient is used. Therefore, first map MP1 updated in learning once may not be the first map most suitable for the current density of air.

For example, the first map most suitable for the density of air at the current location is assumed as first map MP3. Then, when the learning condition is satisfied at that location, the first map is learned by repeated first learning processing, and first map MP1 is updated to first map MP3 through a plurality of times of first learning processing. The first map can thus be learned in consideration of influence by a calculation error.

<<Second Learning Processing>>

When magnitude of difference ΔN is equal to or larger than the prescribed value, second learning processing is performed. In second learning processing, when magnitude of difference ΔN between actual rotation speed Ner of engine 13 and idle rotation speed Nad representing the target value is equal to or larger than the prescribed value while the vehicle is stopped and engine 13 is idle, first MG 14 is initially controlled to set actual rotation speed Ner of engine 13 to idle rotation speed Nad. Output torque of engine 13 in this case remains unchanged.

For example, when an attempt to set actual rotation speed Ner of engine 13 to idle rotation speed Nad is made while opening of throttle valve 49 is adjusted each time, overshoot or undershoot of the rotation speed of engine 13 may be caused. By using first MG 14 to set actual rotation speed Ner of engine 13 to idle rotation speed Nad, actual rotation speed Ner of engine 13 can be set to idle rotation speed Nad while occurrence of overshoot or undershoot of the rotation speed of engine 13 is suppressed. Then, output torque of first MG 14 required for setting rotation speed Ne of engine 13 to idle rotation speed Nad (which is also referred to as “additional torque” below) is calculated and that additional torque is checked against a second map which will be described later, so that amount Cv of correction of opening of throttle valve 49 is calculated. The first map is then updated based on calculated amount Cv of correction of opening of throttle valve 49. Since this update does not involve weighting as in first learning processing, the first map can be suitable for the density of air after it is varied without performing a plurality of times of second learning processing.

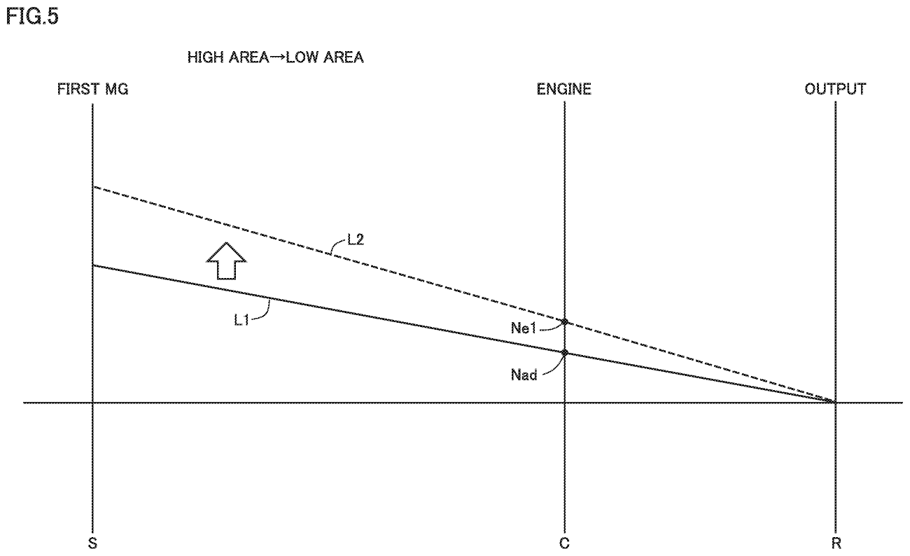

The second learning processing will be described below with reference to specific examples. FIGS. 5 to 8 are nomographic charts showing relation between a rotation speed and torque of engine 13, first MG 14, and an output element when the vehicle is stopped and engine 13 is idle. Ring gear R coupled to countershaft 25 (FIG. 1) functions as the output element. A position on the ordinate represents a rotation speed of each element (engine 13, first MG 14, and the output element) and an interval on the ordinate represents a gear ratio of planetary gear mechanism 20.

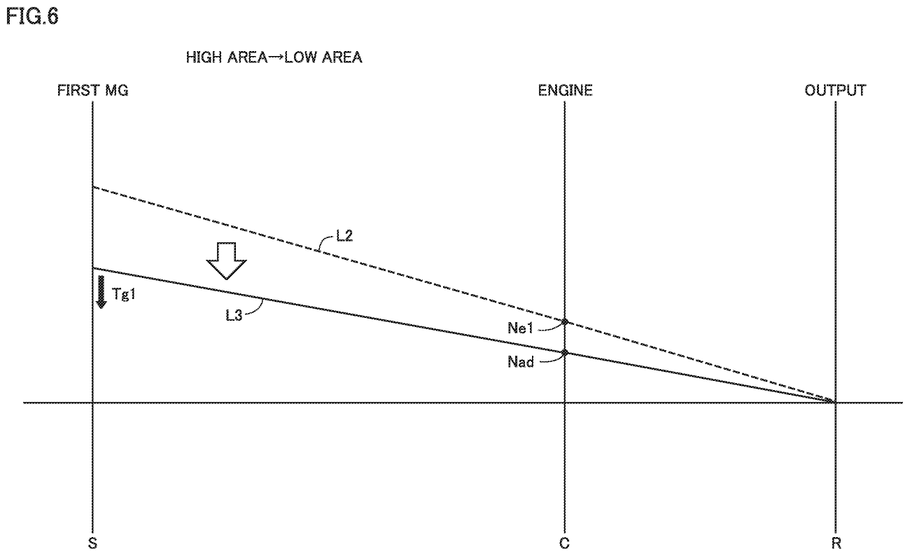

An example in which vehicle 10 that had been used in a high area for a certain period of time has moved to a low area will initially be described with reference to FIGS. 5 and 6. FIGS. 5 and 6 show an example in which vehicle 10 that had been used in a location low in density of air for a certain period of time has moved to a location high in density of air. The first map is assumed to have been learned to a map suitable for the density of air in the high area, for example, through repeated first learning processing in the high area.

Referring to FIG. 5, a solid line L1 represents relation between a rotation speed and torque of engine 13, first MG 14, and the output element in the high area (before moving). A dashed line L2 represents relation between a rotation speed and torque of engine 13, first MG 14, and the output element in the low area (after moving).

In the high area, since the first map has been learned to the map suitable for the density of air in the high area, for example, through the first learning processing, actual rotation speed Ner of engine 13 while the vehicle is stopped and engine 13 is idle attains to idle rotation speed Nad (solid line L1).

When vehicle 10 moves from the high area to the low area, the density of air becomes higher. Therefore, before the first map is learned to a map suitable for the low area through the learning processing, when opening of throttle valve 49 is controlled in accordance with the first map, actual rotation speed Ner of engine 13 while the vehicle is stopped and engine 13 is idle attains to a rotation speed Ne1 (>Nad) higher than idle rotation speed Nad as shown with dashed line L2.

A difference ΔN1 in this case can be expressed in an expression (3) below by substituting rotation speed Ne1 for actual rotation speed Ner of engine 13 in the expression (1).

ΔN1=Ne1−Nad (3)

When magnitude of difference ΔN1 is equal to or larger than a prescribed value, that is, when actual rotation speed Ne1 of engine 13 is higher than idle rotation speed Nad by a prescribed value or more, control such as fuel cut may be carried out. In order to suppress this, ECU 11 calculates output torque (additional torque) of first MG 14 required for setting actual rotation speed Ne1 of engine 13 to idle rotation speed Nad and controls first MG 14 to output torque calculated by addition of additional torque to currently output torque. The rotation speed of engine 13 is thus set to idle rotation speed Nad.

Referring to FIG. 6, FIG. 6 assumes an example in which reaction torque (torque in a negative direction) Tg1 is calculated as additional torque. Specifically, additional torque Tg1 is output in addition to original output torque that has been output from first MG 14. Actual rotation speed Ner of engine 13 while the vehicle is stopped and engine 13 is idle thus attains to idle rotation speed Nad as shown with a solid line L3. When first MG 14 is free (output torque is zero) in a state shown with dashed line L2, first MG 14 outputs additional torque Tg1 as output torque in a state shown with solid line L3.

As first MG 14 outputs additional torque Tg1 in addition to original output torque, actual rotation speed Ner of engine 13 that has attained to rotation speed Ne1 is suppressed to idle rotation speed Nad. Output torque of engine 13 in this case remains unchanged. Actual rotation speed Ner of engine 13 suppressed by first MG 14 is not necessarily limitatively exactly equal in value to idle rotation speed Nad, and an example in which a difference therebetween is within a certain range is also encompassed.

ECU 11 then calculates amount Cv of correction of opening of throttle valve 49 based on additional torque Tg1. Specifically, the ECU reads the second map representing relation between additional torque and the amount of correction of opening from storage 11a and checks additional torque against the second map. Amount Cv of correction of opening of throttle valve 49 is thus calculated. The second map corresponds to exemplary “second information” according to the present disclosure.

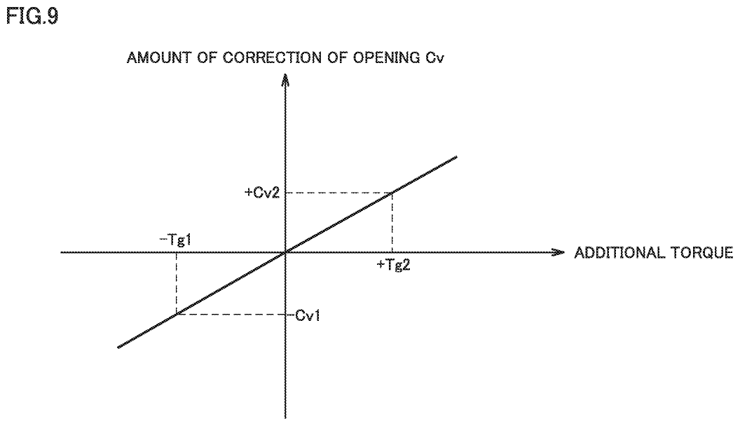

FIG. 9 is a diagram for illustrating an exemplary second map. The abscissa in FIG. 9 represents additional torque and the ordinate represents an amount of correction of opening of throttle valve 49. The second map is stored, for example, in storage 11a of ECU 11. FIG. 9 shows torque in a negative direction with a sign “−” and torque in a positive direction with a sign “+”.

For example, ECU 11 obtains an amount “−Cv1” of correction of opening of throttle valve 49 by checking additional torque “−Tg1” against the second map. The sign “−” for the amount of correction of opening means correction of opening of throttle valve 49 in a decreasing direction. The sign “+” for the amount of correction of opening means correction of opening of throttle valve 49 in an increasing direction. ECU 11 updates opening of throttle valve 49 by adding amount “−Cv1” of correction of opening to opening OP of throttle valve 49. Updated opening of throttle valve 49 can be expressed in an expression (4) below as a general expression.

OP=OP+Cv (4)

Referring again to FIG. 4, ECU 11 corrects the first map based on amount “−Cv1” of correction of opening. Specifically, ECU 11 is assumed to have updated opening of throttle valve 49 for obtaining amount IA of suctioned air to opening OP3 by adding amount “−Cv1” of correction of opening to opening OP of throttle valve 49 for obtaining amount IA of suctioned air. In this case, first map MP3 that passes through amount IA of suctioned air and opening OP3 can be concluded as the first map suitable for the density of air in the low area (after moving). ECU 11 updates first map MP to map MP3 that passes through amount IA of suctioned air and opening OP3.

Namely, currently calculated difference ΔN is reflected on the first map without using a weight coefficient.

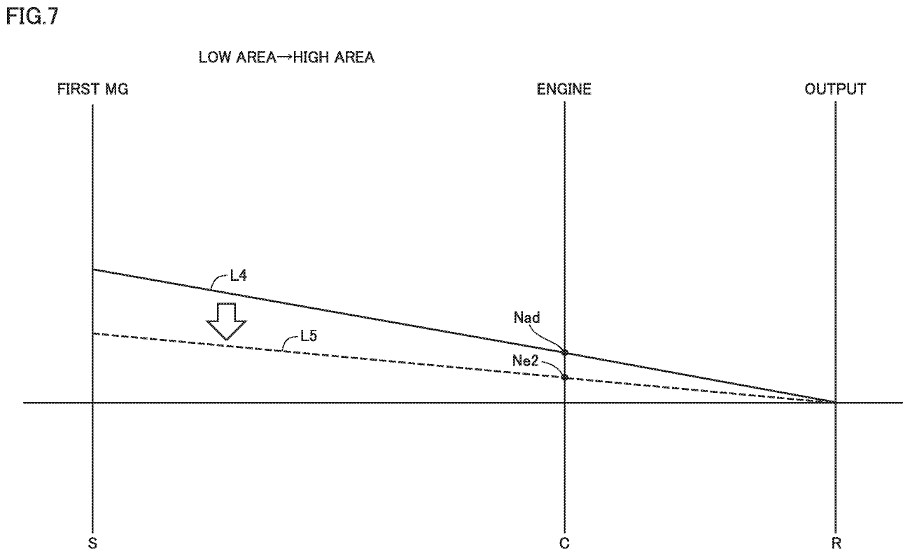

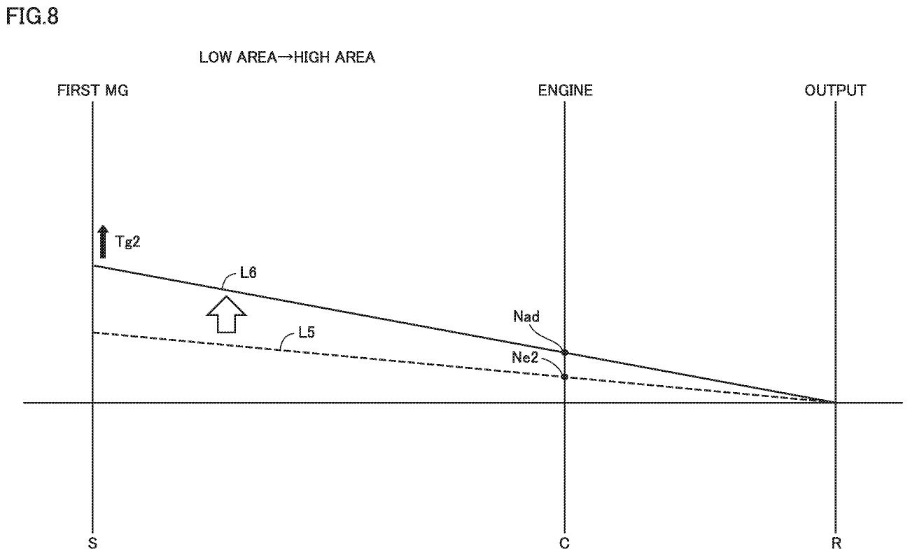

An example in which vehicle 10 that had been used in a low area for a certain period of time has moved to a high area will now be described with reference to FIGS. 7 and 8. FIGS. 7 and 8 show an example in which vehicle 10 that had been used for a certain period of time at a location high in density of air has moved to a location low in density of air. The first map is assumed to have been learned to a map suitable for the density of air in the low area, for example, through repeated first learning processing in the low area.

Referring to FIG. 7, a solid line L4 represents relation between a rotation speed and torque of engine 13, first MG 14, and the output element in the low area (before moving). A dashed line L5 represents relation between a rotation speed and torque of engine 13, first MG 14, and the output element in the high area (after moving).

In the low area, for example, the first map has been updated to the map suitable for the density of air in the low area through first learning processing. Therefore, actual rotation speed Ner of engine 13 while the vehicle is stopped and engine 13 is idle has attained to idle rotation speed Nad (solid line L4).

When vehicle 10 moves from the low area to the high area, the density of air is lowered. Therefore, before learning of the first map to a map suitable for the high area through learning processing, when opening of throttle valve 49 is controlled in accordance with the first map, actual rotation speed Ner of engine 13 while the vehicle is stopped and engine 13 is idle attains to a rotation speed Ne2 (<Nad) lower than idle rotation speed Nad as shown with dashed line L5.

A difference ΔN2 in this case can be expressed in an expression (5) below by substituting rotation speed Ne2 for actual rotation speed Ner of engine 13 in the expression (1).

ΔN2=Ne2−Nad (5)

When magnitude of difference ΔN2 is equal to or larger than a prescribed value, that is, when actual rotation speed Ne2 of engine 13 is lower than idle rotation speed Nad by a prescribed value or more, engine 13 may stall. In order to suppress this, ECU 11 calculates additional torque and controls first MG 14 to output torque calculated by addition of additional torque to currently output torque. Rotation speed Ne2 of engine 13 is thus set to idle rotation speed Nad. A specific method is similar to the method described with reference to FIGS. 5 and 6.

Referring to FIG. 8, FIG. 8 assumes an example in which torque Tg2 is calculated as additional torque. Specifically, additional torque Tg2 is output in addition to original output torque that has been output from first MG 14. Actual rotation speed Ner of engine 13 while the vehicle is stopped and engine 13 is idle thus attains to idle rotation speed Nad as shown with a solid line L6.

ECU 11 checks additional torque Tg2 against the second map and calculates amount Cv of correction of opening of throttle valve 49 as in moving from the high area to the low area.

Referring again to FIG. 9, ECU 11 obtains an amount “+Cv2” of correction of opening of throttle valve 49 by checking additional torque “+Tg2” against the second map.

Referring again to FIG. 4, ECU 11 corrects the first map based on amount “+Cv2” of correction of opening. Specifically, ECU 11 is assumed to have updated opening of throttle valve 49 for obtaining amount IA of suctioned air to opening OP4 by adding amount “+Cv2” of correction of opening to opening OP of throttle valve 49 for obtaining amount IA of suctioned air. In this case, first map MP4 that passes through amount IA of suctioned air and opening OP4 can be concluded as the first map suitable for the density of air in the high area (after moving). ECU 11 updates first map MP to map MP4 that passes through amount IA of suctioned air and opening OP4.

When magnitude of difference ΔN between actual rotation speed Ner of engine 13 while the vehicle is stopped and engine 13 is idle and idle rotation speed Nad is equal to or larger than the prescribed value, first MG 14 is controlled to set actual rotation speed Ner of engine 13 to idle rotation speed Nad. By setting actual rotation speed Ner of engine 13 to idle rotation speed Nad by controlling first MG 14, actual rotation speed Ner of engine 13 can be set to idle rotation speed Nad while occurrence of overshoot or undershoot of the rotation speed of engine 13 is suppressed.

The first map is then updated as above based on additional torque of first MG 14 required for setting actual rotation speed Ner of engine 13 to idle rotation speed Nad. The first map can thus be updated to the map suitable for the density of air after moving without performing a plurality of times of learning processing.

<Processing Performed by Controller>

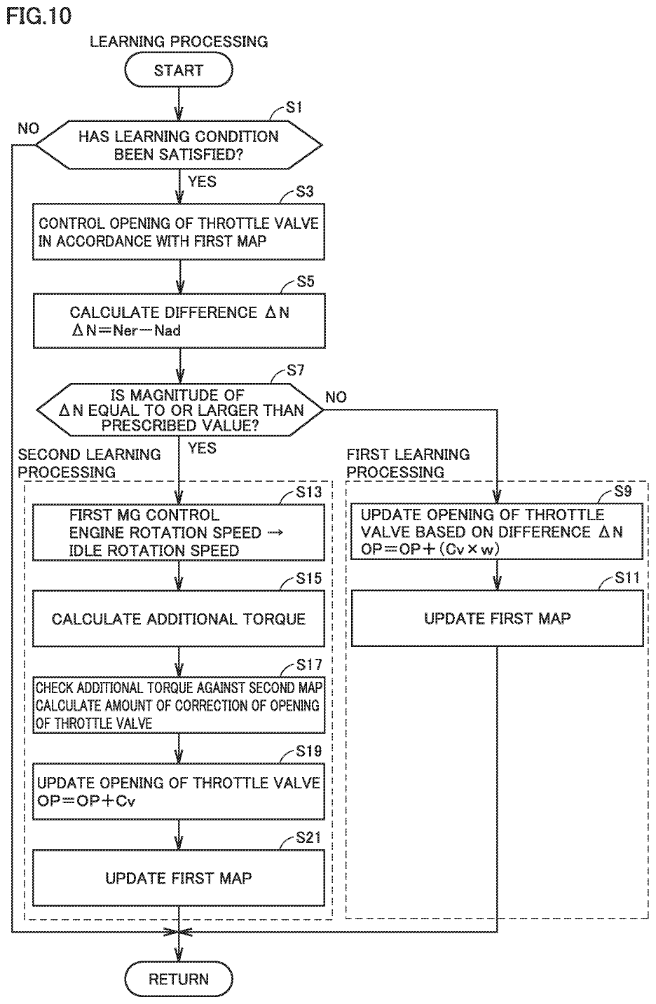

FIG. 10 is a flowchart showing a procedure in processing performed by ECU 11. The flowchart is repeatedly performed by ECU 11 every prescribed control period. Though an example in which steps (the step being abbreviated as “S” below) shown in FIG. 10 are performed by software processing by ECU 11 is described, some or all of them may be performed by hardware (electrical circuits) fabricated in ECU 11.

ECU 11 determines whether or not a learning condition has been satisfied (S1). Specifically, ECU 11 determines whether or not the vehicle is stopped and engine 13 is idle. When the learning condition has not been satisfied (NO in Si), ECU 11 quits the process.

When the learning condition has been satisfied (YES in S1), ECU 11 starts learning processing. Specifically, initially, ECU 11 reads the first map from storage 11a and controls opening of throttle valve 49 in accordance with the first map (S3). Specifically, ECU 11 calculates required amount IA of air suctioned into engine 13 based on idle torque Tad required for maintaining idle rotation speed Nad. ECU 11 obtains a target value of opening of throttle valve 49 by checking amount IA of suctioned air against the first map. ECU 11 then controls throttle valve 49 to set opening thereof to the target value.

ECU 11 then calculates difference ΔN between actual rotation speed Ner of engine 13 at the time when throttle valve 49 is controlled in accordance with the first map and idle rotation speed Nad, in accordance with the expression (1) described above. ECU 11 then determines whether or not magnitude of difference ΔN calculated in S5 is equal to or larger than a prescribed value (S7).

When magnitude of difference ΔN is smaller than the prescribed value (NO in S7), ECU 11 performs first learning processing. When magnitude of difference ΔN is smaller than the prescribed value, fuel cut control or stall of engine 13 is less likely. Then, in this case, in consideration of the possibility that difference ΔN contains variation in calculation, ECU 11 updates opening of throttle valve 49 for obtaining amount IA of suctioned air in accordance with the expression (2) described above with currently calculated difference ΔN being weighted, and further updates the first map.

More specifically, initially, ECU 11 converts difference ΔN to amount Cv of correction of opening of throttle valve 49. ECU 11 then updates opening of throttle valve 49 for obtaining amount IA of suctioned air with amount Cv of correction of opening of throttle valve 49 being weighted (S9). ECU 11 then updates the first map to the first map that passes through amount IA of suctioned air and updated opening of throttle valve 49 (S11).

When magnitude of difference ΔN is equal to or larger than the prescribed value (YES in S7), ECU 11 performs second learning processing. When magnitude of difference ΔN is equal to or larger than the prescribed value, fuel cut control or stall of engine 13 is likely. In order to avoid this, ECU 11 reflects current difference ΔN on the first map without weighting as in the first learning processing. Specifically, initially, ECU 11 controls first MG 14 to set actual rotation speed Ner of engine 13 to idle rotation speed Nad (S13). Output torque of engine 13 in this case is not varied.

ECU 11 then calculates output torque (additional torque) of first MG 14 required for setting actual rotation speed Ner of engine 13 to idle rotation speed Nad (S15).

ECU 11 then reads the second map from storage 11 a and checks additional torque calculated in S15 against the second map. ECU 11 thus calculates amount Cv of correction of opening of throttle valve 49 (S17).

ECU 11 updates opening of throttle valve 49 for obtaining amount IA of suctioned air in accordance with the expression (4) described above, by using amount Cv of correction of opening calculated in S17 (S19). ECU 11 updates the first map to the first map that passes through amount IA of suctioned air and updated opening of throttle valve 49 (S21).

As set forth above, when magnitude of difference ΔN between actual rotation speed Ner of engine 13 while the vehicle is stopped and engine 13 is idle and idle rotation speed Nad is equal to or larger than the prescribed value, second learning processing is performed. In the second learning processing, initially, first MG 14 is controlled to set actual rotation speed Ner of engine 13 to idle rotation speed Nad. By using first MG 14, actual rotation speed Ner of engine 13 can be set to idle rotation speed Nad while occurrence of overshoot or undershoot of the rotation speed of engine 13 is suppressed.

Amount Cv of correction of opening of throttle valve 49 is obtained based on additional torque of first MG 14 required for setting actual rotation speed Ner of engine 13 to idle rotation speed Nad. Opening of throttle valve 49 for obtaining amount IA of air suctioned into engine 13 is updated with amount Cv of correction of opening, and the current first map is corrected to the first map that passes through amount IA of suctioned air and updated opening of throttle valve 49. The first map can thus be updated to the map suitable for the density of air after moving, without performing a plurality of times of learning processing. As engine 13 is controlled in accordance with the updated first map, engine 13 can be controlled as desired.

The first map updated through learning processing as above is used also in the forced induction region where forced induction device 47 is activated. For example, the first map, that is, information representing relation between opening of throttle valve 49 and an amount of air suctioned into engine 13, may be prepared for each of the non-forced induction region and the forced induction region. In this case, the first map used in the forced induction region is desirably learned in a prescribed state in which forced induction device 47 is activated.

In the forced induction region, however, due to influence by variation in boost pressure, accuracy in learning may be lower than in the non-forced induction region.

In the present embodiment, opening of throttle valve 49 is controlled also in the forced induction region in accordance with the first map learned while the vehicle is stopped and engine 13 is idle. By using the map learned in the non-forced induction region, control of engine 13 suitable for the density of air after it is varied can be carried out also in the forced induction region where it is difficult to secure accuracy in learning.

(First Modification)

In the embodiment, a condition that the vehicle is stopped and engine 13 is idle is defined as the learning condition. The learning condition, however, is not limited to the condition that the vehicle is stopped and engine 13 is idle, and it should only be a condition that stable learning can be ensured. For example, while engine 13 is in the idle state which is the steady state, stable learning can be performed.

In a first modification, an example in which a condition that the vehicle is traveling and engine 13 is idle is defined as the learning condition is described. In the hybrid vehicle, engine 13 can be idle also during traveling.

Specifically, in switching from the HV traveling mode to the EV traveling mode, ECU 11 performs learning processing and thereafter carries out idling stop control. Specifically, when switching from the HV traveling mode to the EV traveling mode is made, ECU 11 performs learning processing with engine 13 being set to the idle state and stops engine 13 after learning processing.

While the vehicle is traveling and engine 13 is idle, target rotation speed (idle rotation speed) Nad of engine and torque (idle torque) Tad of engine 13 required for maintaining idle rotation speed Nad as in the embodiment are determined.

As learning processing is performed while the vehicle is traveling and engine 13 is idle, that is, learning processing is performed while engine 13 is in the idle state which is the steady state, stable learning as in the embodiment can be performed.

(Second Modification)

In the embodiment, a condition that the vehicle is stopped and engine 13 is idle is defined as the learning condition. In the first modification, a condition that the vehicle is traveling and engine 13 is idle is defined as the learning condition. Combination of the above conditions can also be defined as the learning condition. Specifically, (1) the condition that the vehicle is stopped and engine 13 is idle or (2) the condition that the vehicle is traveling and engine 13 is idle may be defined as the learning condition. When either (1) or (2) is satisfied, learning processing is performed.

The case (1) that the vehicle is stopped and engine 13 is idle and the case (2) that the vehicle is traveling and engine 13 is idle both fall under the case that engine 13 is in the idle state which is the steady state. Therefore, by performing learning processing under such a condition, stable learning can be performed as in the embodiment and the first modification.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A hybrid vehicle comprising:
an internal combustion engine;
a rotating electric machine;
a planetary gear mechanism to which the internal combustion engine, the rotating electric machine, and an output shaft are connected;
a throttle valve provided in an air intake passage of the internal combustion engine; and
a controller that controls opening of the throttle valve in accordance with first information representing relation between opening of the throttle valve and an amount of air suctioned into the internal combustion engine, wherein
the controller performs learning processing for learning the first information while the internal combustion engine is idle, and
the learning processing includes
processing for setting a rotation speed of the internal combustion engine to a predetermined target rotation speed by controlling the rotating electric machine, and
processing for learning the first information in accordance with second information representing relation between torque of the rotating electric machine required for setting the rotation speed of the internal combustion engine to the target rotation speed and an amount of correction of opening of the throttle valve.

2. The hybrid vehicle according to claim 1, wherein
the controller performs the learning processing when magnitude of a difference between the rotation speed of the internal combustion engine while the internal combustion engine is idle and the target rotation speed is equal to or larger than a prescribed value.

3. The hybrid vehicle according to claim 1, wherein
the internal combustion engine includes a forced induction device.
